(19) United States
(12) Patent Application Publication
(10) Pub. No.: US 2024/0411284 A1
(43) Pub. Date: Dec. 12, 2024

(54) METHOD AND SYSTEM FOR ENABLING A SAFETY-CRITICAL FUNCTION OF A MACHINE

(71) Applicant: TRUMPF Werkzeugmaschinen SE + Co. KG, Ditzingen (DE)

(72) Inventors: Thorsten Larsen-Vefring, Stuttgart (DE); Klaus Bauer, Ditzingen (DE); Hans-Peter Bock, Bietigheim-Bissingen (DE)

(21) Appl. No.: 18/811,859

(22) Filed: Aug. 22, 2024

Related U.S. Application Data
(63) Continuation of application No. PCT/EP2023/053498, filed on Feb. 13, 2023.

(30) Foreign Application Priority Data
Mar. 3, 2022 (DE) 10 2022 105 018.1

(51) Int. Cl. G05B 19/406

(52) U.S. Cl. CPC G05B 19/406; G05B 2219/50193

(57) ABSTRACT

A method for enabling a safety-critical function of a machine includes monitoring a safety-critical region of the machine using a monitoring system. The monitoring system includes at least one monitoring sensor. The method further includes blocking the safety-critical function upon detecting by the monitoring system a first risk in a first signal of the monitoring sensor, combining the first signal of the monitoring sensor at a first point in time with a first identifier to form a first message, sending the first message by the monitoring system to an enabling unit, receiving by the monitoring system from the enabling unit, at a second point in time, a second message with an enabling signal and the first identifier, verifying the second message by the monitoring system, and enabling the safety-critical function by the monitoring system if the verification of the second message is successful.

### CROSS REFERENCE TO RELATED APPLICATIONS

This application is a continuation of International Application No. PCT/EP2023/053498 (WO 2023/165802 A1), filed on Feb. 13, 2023, and claims benefit to German Patent Application No. DE 10 2022 105 018.1, filed on Mar. 3, 2022. The aforementioned applications are hereby incorporated by reference herein.

### BACKGROUND OF THE INVENTION

### Field

Embodiments of the present invention relate to a method for enabling a safety-critical function of a machine. Embodiments of the present invention further relate to a system for enabling a safety-critical function of a machine.

### Background

It is known to monitor spatial regions using sensors and to stop machines if the sensors detect a risk in the respective region. A risk can be, for example, a person or an object that is not expected in this region.

Typically, the machine is stopped or otherwise brought into a safe state as soon as one of the sensors detects a risk. Any computing unit for evaluating the sensor signals, which may be present, is considered as part of the sensor here. An enabling of the stopped machine is typically only possible with a visual inspection of the monitored region. It is therefore necessary for a person to be in the immediate vicinity of the monitored region for enabling purposes.

A control device is known from DE 10 2016 226 133 A1 that can be switched from an alarm state to a normal state by a transmitter with a light signal.

### SUMMARY

Embodiments of the present invention provide a method for enabling a safety-critical function of a machine. The method includes monitoring a safety-critical region of the machine using a monitoring system. The monitoring system includes at least one monitoring sensor. The method further includes blocking the safety-critical function upon detecting by the monitoring system a first risk in a first signal of the monitoring sensor, combining the first signal of the monitoring sensor at a first point in time with a first identifier to form a first message, sending the first message by the monitoring system to an enabling unit, receiving by the monitoring system from the enabling unit, at a second point in time, a second message with an enabling signal and the first identifier, verifying the second message by the monitoring system, and enabling the safety-critical function by the monitoring system if the verification of the second message is successful.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a monitoring system according to some embodiments;

FIG. 2 shows a schematic sequence of the communication between the monitoring system and the enabling unit according to some embodiments; and

FIG. 3 shows a chronological sequence of a method according to the invention according to some embodiments.

### DETAILED DESCRIPTION

Embodiments of the present invention provide a system and a method which simplifies the enabling of a machine.

According to embodiments of the invention, a method for enabling a safety-critical function of a machine is provided, wherein a monitoring system monitors a safety-critical region of the machine, wherein the monitoring system comprises at least one monitoring sensor,

wherein the safety-critical function is blocked when the monitoring system detects a first risk in a signal of the monitoring sensor, wherein a first signal of the monitoring sensor is combined at a first point in time with a first identifier to form a first message, wherein the first message is sent by the monitoring system to an enabling unit,
wherein at a second point in time a second message with an enabling signal and the first identifier is received by the monitoring system, wherein the second message is verified by the monitoring system, wherein the safety-critical function is enabled by the monitoring system if the verification of the second message is successful.

Possible sensors for monitoring the region are, for example, light barriers, contact sensors on doors, ultrasonic sensors, radar sensors or cameras. The sensors can monitor a boundary of a region and/or the region itself.

The signal from a camera or another imaging sensor, i.e., an image or preferably an image stream, is preferably used for sending the first message. This is advantageous if a person is to evaluate the situation at the enabling unit.

The identifier enables the monitoring system to assign the second message to the first message. This is advantageous when sending multiple messages with signals of the monitoring sensor via a network where the chronological order of messages is not guaranteed, such as the Internet.

A verification of the second message is considered as successful if it does not fail for at least one reason. Possible reasons for the verification failing are listed below.

Preferably, at a third point in time, a second signal of the monitoring sensor is combined with a second identifier to form a third message, wherein the third point in time is after the first point in time, wherein the second identifier is different from the first identifier, wherein the chronological order of the signals can be determined by means of the identifiers.

The second signal is the same signal as the first signal, with the difference that the second signal was generated by the monitoring sensor at a later point in time, preferably an image or a sequence of images taken at the later point in time. The third message can therefore be treated as a first message by the enabling unit.

It is understood that further messages can be sent with respectively current signals of the monitoring sensor. This means that a situation that has changed after the function was blocked can also be evaluated at the enabling unit. The further messages each receive their own identifier. The messages are preferably sent periodically. This is advantageous if each message contains one or more images from an image stream of a camera.

The identifier is preferably a timestamp. Timestamps make it easy to determine the chronological order of the messages.

Preferably, the first identifier is a cryptographically signed timestamp, wherein the verification of the enabling signal fails if a validation of the first cryptographically signed timestamp from the second message fails. Cryptographically signed timestamps are known, for example, from the RFC3161 standard or the ANSI ASC X9.95 standard. Further information can also be found under https://en.wikipedia.org/wiki/Trusted_timestamping

Cryptographically signed timestamps are advantageous, as enabling signals with an arbitrary timestamp lead to failure of the verification. Malfunctions of the enabling unit therefore do not lead to an incorrect enabling of the safety-critical function.

The second message is preferably provided with a second cryptographic signature from the enabling unit, wherein the verification of the second message fails if a validation of the second cryptographic signature fails. The second signature can, for example, be created using a private key of the enabling unit, wherein the public key associated with the private key is stored in the monitoring system in order to verify the second signature. The cryptographic signature can be used to ensure that the second message originates from the enabling unit and not from an unknown unit.

Preferably, the verification of the second message fails if the monitoring system detects a second risk between the first point in time and the second point in time. Just as the first risk, the second risk is detected from the signals of the monitoring sensor or another monitoring sensor. The safety-critical function is only enabled if the message with the enabling signal has an identifier that refers to a point in time after the last detected risk. The verification of enabling signals with other identifiers will result in the failure of the verification.

In a preferred embodiment, the first message is additionally sent to a second enabling unit, wherein a second message from the second enabling unit with an enabling signal and the first identifier is handled by the monitoring system in the same way as the second message from the first enabling unit. Sending the first message to a second enabling unit allows for the function to be enabled by two enabling unit. This is advantageous if an enabling unit fails or if an operator is unable to operate a manually operated enabling unit.

A second aspect of the invention relates to a system for enabling a safety-critical function of a machine, in particular a machine tool, comprising the machine, a monitoring system and an enabling unit, wherein the monitoring system has at least one monitoring sensor for monitoring a safety-critical region of the machine, wherein the monitoring system and the enabling unit are connected in a communicating manner, wherein the monitoring system comprises a computing unit, wherein the computing unit is provided and designed to evaluate a first signal of the monitoring sensor and to block the safety-critical function of the machine if the computing unit detects a first risk in the first signal of the monitoring sensor, wherein the monitoring system is provided and designed to combine the first signal of the monitoring sensor with a first identifier and to transmit it in a first message to the enabling unit, wherein the monitoring system is provided and designed to receive a second message with an enabling signal and the first identifier from the enabling unit, wherein the monitoring system is provided and designed to verify the second message and to enable the safety-critical function of the machine if the verification of the second message is successful.

The computing unit can comprise a processor, an FPGA, an ASIC, a controller or another computing device. The computing unit can be part of the machine or be an independent unit.

The system is preferably provided and designed to carry out preferred embodiments of the method according to embodiments of the invention.

The monitoring sensor is preferably a camera. Signals of a camera can be verified particularly easily by a person.

A further monitoring sensor is preferably a light barrier, a contact sensor, an ultrasonic sensor, a radar sensor or a lidar sensor. Additional sensors increase safety, as more potential risks can be detected.

Preferably, the timestamp is a cryptographically signed timestamp, wherein the monitoring system is provided and designed to validate the timestamp received in the second message and to cause the verification of the second message to fail if the validation fails.

Preferably, the monitoring system is provided and designed to compare a second point in time of receiving the second messages with a first point in time defined by the first identifier from the second message and to cause the verification of the second message to fail if the difference between the first point in time and the second point in time is greater than a predetermined limit value.

Preferably, the monitoring system is provided and designed to cause the verification of the second message to fail if the monitoring system detects a second risk in a second signal of the monitoring sensor between the first point in time and the second point in time.

Preferably, the second message is provided with a cryptographic signature of the enabling unit and the monitoring system is provided and designed to validate the cryptographic signature of the second message and to cause the verification of the second message to fail if the validation of the cryptographic signature fails.

The following description serves to explain the embodiments of the invention in greater detail in association with the drawings.

Elements that are the same or have equivalent functions are denoted by the same reference signs in all of the exemplary embodiments. The exemplary embodiments are described with a single enabling unit. If multiple enabling units are used, the first messages of the monitoring system are respectively sent to all enabling units and the second messages of the enabling units are handled in the same manner by the monitoring system.

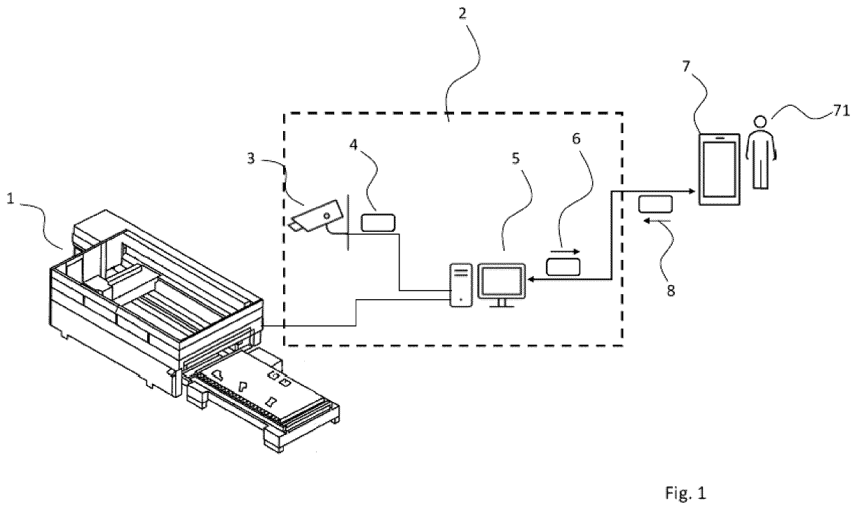

A schematic view of a monitoring system 2 is shown in FIG. 1. A region around a machine 1, in this case a laser cutting machine, is monitored by means of a monitoring sensor 3, in this case a camera. The monitoring sensor 2 sends a signal 4, in this case a sequence of images, to a computing unit 5. If the computing unit 5 detects a risk in the signal 4, the computing unit 5 blocks a safety-critical function of the machine 1 so that no damage occurs. Preferably, the entire machine 1 is stopped or brought into a safe state.

The computing unit 5 combines the signal 4 with a first identifier to form a first message 6. The computing unit 5 sends the first message 6 to an enabling unit 7. In this case, the enabling unit 7 is a smartphone. The enabling unit 7 verifies whether the risk is recognizable in the signal 4 or whether the risk is not or no longer present. In this example, an operator 71 of the enabling unit verifies the signal 4. If no risk is recognizable in the signal 4, whether due to faulty detection by the computing unit 5 or because the risk was of a temporary nature, the enabling unit 7 generates a second message 8 with an enabling signal and the first identifier and sends the second message 8 to the computing unit of the monitoring system 2. The computing unit 5 verifies the second message 8. If the verification is successful, the computing unit 5 enables the safety-critical function of the machine 1. If the verification of the second message 8 fails, the function remains blocked.

The computing unit 5 generates, preferably periodically, further messages 6 with current signals 4 of the monitoring sensor 3 and an individual identifier in each case. This allows the enabling unit 7 to verify whether the risk has disappeared at a later point in time and then send an enabling signal with the identifier of that message 6 in which the risk is no longer detectable.

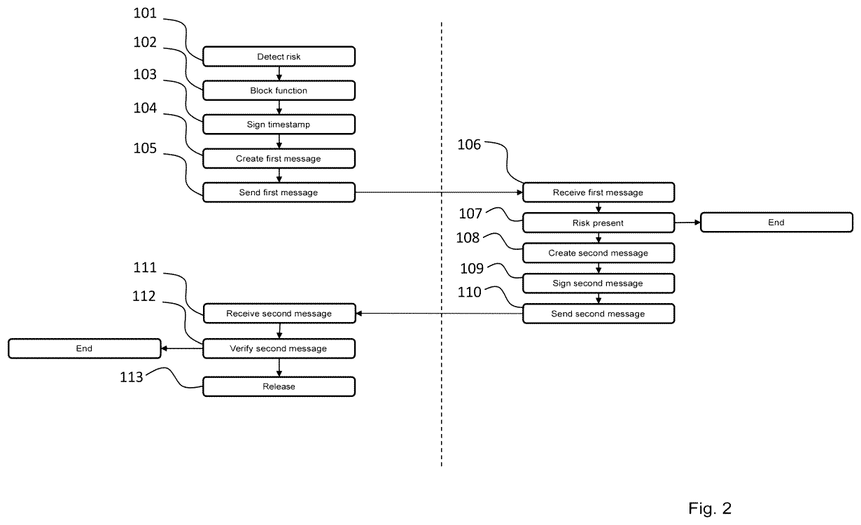

FIG. 2 shows a schematic sequence of the communication between the monitoring system and the enabling unit. In a first step 101, the monitoring system 2 detects a first risk. In a second step 102, the monitoring system 2 blocks a safety-critical function of the machine 1. In a third step 103, the monitoring system 2 generates a signed timestamp as an identifier. In a fourth step 104, the monitoring system generates a first message 6, wherein the first message 6 contains both the signal 4 and the identifier. In a fifth step 105, the monitoring system 2 sends the first message 6 to an enabling unit 7 at a first point in time. As the steps are typically performed by a computing unit in rapid succession, the point in time defined by the timestamp is equated with the first point in time.

In a sixth step 106, the enabling unit 7 receives the first message 6. In a seventh step 107, the enabling unit 7 verifies whether a risk can be detected in the signal 4. If the risk in the signal 4 is detected by the enabling unit 7 in the seventh step, the method terminates. If the enabling unit 7 does not detect any risk in the signal 4, the enabling unit 7 creates a second message 8 in an eighth step 108. In this regard, the second message 8 contains an enabling signal and the identifier of that first message 6 in which no risk was detected. The second message 8 is signed by the enabling unit 7 in a ninth step 109. In a tenth step 110, the enabling unit 7 sends the signed second message 8 to the monitoring system 2.

The monitoring system 2 receives the second message 8 at a second point in time in an eleventh step 111. In a twelfth step 112, the monitoring system 2 verifies the second message 8. During this verification, the monitoring system 2 verifies the signature of the second message 8. If the signature is not from the enabling unit 7, the verification fails and the method terminates. If the first identifier is a signed timestamp, the monitoring system verifies whether the signature of the timestamp is valid. If the signature of the timestamp is invalid, the verification fails and the method terminates. The monitoring system 2 verifies whether a second risk has been detected in the signal 4 of the monitoring sensor 2 between a first point in time, which is determined by the first identifier, and the second point in time. As the steps are typically performed by a computing unit in rapid succession, the second point in time is equated with the point in time of the verification. If a second risk was detected, the verification fails and the method terminates. If the verification does not fail, the verification is successful and the monitoring system enables the safety-critical function of the machine 1 in a thirteenth step 113.

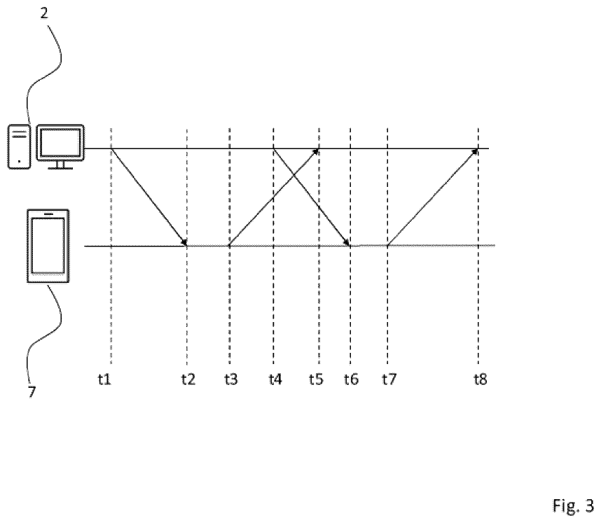

FIG. 3 shows a chronological sequence of a method according to embodiments of the invention. At a point in time t1, the monitoring system 2 detects a first risk in a signal 4 of the monitoring sensor 3, blocks the safety-critical function of the machine and sends a first message 6 with the signal of the point in time t1 and a first identifier to an enabling unit 7. At a point in time t2, the enabling unit 7 receives the first message 6. After verifying the signal and determining that there is no risk, the enabling unit 7 sends a second message 8 with an enabling signal to the monitoring system 2 at a point in time t3.

At a point in time t4, which is after the point in time t1, the monitoring system detects a second risk in a signal of the monitoring sensor and sends a third message with the signal 4 of the point in time t4 and a second identifier to the enabling unit 7. The safety-critical function was already blocked at the point in time t1. The point in time t4 is after the point in time t3 in this case, but could also be before the point in time t3 or before the point in time t2.

At a point in time t5, which is after the point in time t4, the monitoring system 2 receives the second message 8. The verification of the second message 8 fails because a second risk was detected at the point in time t4 between the points in time t1 and t5. The safety-critical function therefore remains blocked.

At a point in time t6, the enabling unit 7 receives the third message 6. After verifying the signal and determining that there is no risk, the enabling unit 7 sends a fourth message 8 with an enabling signal to the monitoring system 2 at a point in time t7. At a point in time t8, the monitoring system 2 receives the fourth message 8. After the successful verification of the fourth message, the monitoring system enables the safety-critical function of the machine.

It can be seen that the third message is equivalent to the first message and the fourth message is equivalent to the second message. Accordingly, the third message and the fourth message are handled by the monitoring system and the enabling unit in the same way as the first message and the second message. Similarly, the point in time t4 is equivalent to the point in time t1 and the point in time t8 is equivalent to the point in time t5.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Machine
2 Monitoring system
3 Monitoring sensor
4 Signal
5 Computing unit
6 First message
7 Enabling unit
71 Operator
8 Second message
t1-t8 Points in time

1. A method for enabling a safety-critical function of a machine, the method comprising:
monitoring a safety-critical region of the machine using a monitoring system, wherein the monitoring system comprises at least one monitoring sensor,
blocking the safety-critical function upon detecting by the monitoring system a first risk in a first signal of the monitoring sensor,
combining the first signal of the monitoring sensor at a first point in time with a first identifier to form a first message,
sending the first message by the monitoring system to an enabling unit,
receiving by the monitoring system from the enabling unit, at a second point in time, a second message with an enabling signal and the first identifier,
verifying the second message by the monitoring system, and
enabling the safety-critical function by the monitoring system if the verification of the second message is successful.

2. The method according to claim 1, further comprising, at a third point in time, combining a second signal of the monitoring sensor with a second identifier to form a third message, wherein the third point in time is after the first point in time, wherein the second identifier is different from the first identifier, and wherein a chronological order of the first signal and the second signal are capable of being determined by the first identifier and the second identifier.

3. The method according to claim 1, wherein the first identifier is a timestamp.

4. The method according to claim 1, wherein the first identifier is a first cryptographically signed timestamp, wherein the verification of the second message fails if a validation of the first cryptographically signed timestamp from the second message fails.

5. The method according to claim 1, wherein the second message is provided with a second cryptographic signature from the enabling unit, wherein the verification of the second message fails if a validation of the second cryptographic signature fails.

6. The method according to claim 1, wherein the verification of the second message fails if a second risk is detected by the monitoring system between the first point in time and the second point in time.

7. The method according to claim 1, further comprising:
sending the first message to a second enabling unit,
receiving a fourth message from the second enabling unit with a second enabling signal and the first identifier,
verifying the fourth message by the monitoring system, and
enabling the safety-critical function by the monitoring system if the verification of the fourth message is successful.

8. A system for enabling a safety-critical function of a machine, the system comprising:
the machine,
a monitoring system, and
an enabling unit,
wherein the monitoring system comprises at least one monitoring sensor for monitoring a safety-critical region of the machine,
wherein the monitoring system and the enabling unit are communicatively connected with each other,
wherein the monitoring system comprises a computing unit configured to:
evaluate a first signal of the monitoring sensor, and
block the safety-critical function of the machine upon detecting a first risk in the first signal of the monitoring sensor,
combine the first signal of the monitoring sensor with a first identifier to form a first message,
transmit the first message to the enabling unit,
receive a second message with an enabling signal and the first identifier from the verify the second message, and
enabling unit,
enable the safety-critical function of the machine if the verification of the second message is successful.

9. The system according to claim 8, wherein the monitoring sensor is a camera.

10. The system according to claim 8, further comprising a further monitoring sensor, the further monitoring sensor being one of a light barrier, a contact sensor, an ultrasonic sensor, a radar sensor, or a lidar sensor.

11. The system according to claim 8, wherein the first identifier is a timestamp.

12. The system according to claim 11, wherein the timestamp is a cryptographically signed timestamp, wherein computing unit of the monitoring system is further configured to validate the timestamp received in the second message, and to cause the verification of the second message to fail if the validation fails.

13. The system according to claim 8, wherein the computing unit of the monitoring system is further configured to compare a second point in time of receiving the second messages with a first point in time defined by the first identifier from the second message, and to cause the verification of the second message to fail if a difference between the first point in time and the second point in time is greater than a predetermined limit value.

14. The system according to claim 13, wherein the computing unit of the monitoring system is configured to cause the verification of the second message to fail if the monitoring system detects a second risk in a second signal of the monitoring sensor between the first point in time and the second point in time.

15. The system according to claim 8, wherein the second message is provided with a cryptographic signature of the enabling unit, and the computing unit of the monitoring system is configured to validate the cryptographic signature of the second message, and to cause the verification of the second message to fail if the validation of the cryptographic signature fails.
